(19) United States
(12) Patent Application Publication
(10) Pub. No.: US 2017/0124277 A1
(43) Pub. Date: May 4, 2017

(54) Systems and Methods for Automated and Remote Care Giving

(71) Applicant: Wolf Shlagman, Miami Beach, FL (US)

(72) Inventor: Wolf Shlagman, Miami Beach, FL (US)

(21) Appl. No.: 15/343,204

(22) Filed: Nov. 3, 2016

Related U.S. Application Data
(60) Provisional application No. 62/250,324, filed on Nov. 3, 2015.

(51) Int. Cl. G06F 19/00

(52) U.S. Cl. CPC G06F 19/3418; G06Q 50/01

(57) ABSTRACT

Disclosed are various embodiments for systems and methods for assisting in providing care giving by one or more care givers in a care circle to a care recipient. The system has at least a central processing station, a network, at least one electronic care giver computing or mobile device, at least one care recipient communication device including of at least a wired telephone, and an interactive software package to be executed on said care giver device to facilitate monitoring of a care recipient and to communicate between a care giver device and a central processing station. A care giver provides a profile including medical history and other related care giving information to a central processing station from a care giver device and sets up interactive communications to be performed between the central processing station and the care recipient communication device.

### FIELD OF THE INVENTION

The present invention relates generally to software applications and systems allowing for automated social interactions, status updates and messaging between a care recipient and a care giver, and more particularly, to enabling status reports, social interactions, wellness checks, mood checks, alerts, and emergency communication between a care recipient and one or more care givers in a care circle in order to monitor and assist with care giving to a care recipient.

### BACKGROUND OF THE INVENTION

Being a care giver to a sick, injured or aging family member can cause major disruptions for a family, and significantly affect the career and choices of a family care giver. In many instances where a person has a person needing certain care, such as an aged parent or grandparent, that person will have to take significant time off work to assist in the care of that care recipient. In addition, and in most cases, the time needed for a care giver to provide such care to the care recipient will take the care giver away from their own spouse and children, thus putting an added strain on a care giver household.

Other stresses arise where additional siblings or friends of a care recipient are involved in assisting the care recipient. As more people are involved, it is difficult to track what each care giver is monitoring or providing certain care giving services. Moreover it tends to cause feelings of mistrust and resentment among the various caregivers, and often overstresses a single care giver because of the increased communication amongst the various care givers attempting to assist. Thus there remains an unmet need to provide assistance to one of more care givers to effectively provide stress-free and efficient care giving to a care recipient.

Several systems and methods are available which do not account for this unmet need. Some solutions include a service to have a dedicated person to live, babysit, or act as a concierge for a portion of a day. While this may reduce the need for a care giver to miss work or miss time with their spouse or children, it requires a substantial amount of money to afford, and still does not account for various care givers attempting to “help”. In addition while some of these services do include nurses, a bulk of the home care industry includes untrained individuals who are unfamiliar with the medical needs, or personal needs, of a care recipient. Thus there remains an unmet need to provide affordable home care to a care recipient.

Some consumer devices have introduced to aide in care giving. The advantage offered by some of these devices is the ability to attempt to provide care to a care recipient remotely. However, these solutions have many shortcomings. First, many of these solutions require a care recipient to hold, or be tethered to or near a device for them to alert for help. In almost all cases, when an event occurs where a care recipient may need assistance, the care recipient is usually unable to immediately reach or interact with that device to seek help. Since these devices are help on demand, no help is offered in those situations until a care recipient can make it to the transponder, and no one is notified that the care giver cannot access the transponder. Thus there remains an unmet need to have a remote care giving monitoring system that does not require a care recipient to have any special equipment, and a system which relies on the continued interaction of a care recipient, alerting for help or assistance of a care giver based on specific interactions, or lack of interaction, with the system.

In addition, while having multiple family members and friends providing assistance is daunting on its own, typically care recipients have several doctors, each proscribing different treatments, medications and other therapies each at different intervals and/or at different times of the day. In addition, with the many medications and treatments that may be employed, it is easy to mis-track the availability of medications at the care recipients disposal. Often, a care recipient does not remember to fill a prescription when it is running low causing unneeded stress on a care giver to ensure that a prescription can be filled, typically in a very short period of time. Thus there further remains an unmet need for a system to integrate medical providers and pharmacies to ensure the continued care and availability of prescription medications is not inadvertently interrupted.

Other problems that are specifically encountered in the elderly community is aversion to technology. It is generally known that the elderly typically do not use, and in some cases, have no interest in learning to use new technology. Other factors affecting this decision are cost and the reliance on one or more additional technologies to enable the new technology to work. For instance, computers also need an internet connection which can be a wired connection to a modem, or through a wireless router. The cost of all the additional technology needed can be cost prohibitive especially since most senior citizens are limited to small social security checks that could support costs of cable internet, wi-fi or a cellular data plan. Thus there remains an unmet need to use existing technology that can be implemented into a care giving system without new or additional technology required by the care recipient.

Finally, home care solutions seem to be focused only on easing the stresses and reliance on a particular care giver, however do not give any regards to the care recipient. In most cases, care giving assistance fails as a result of the lack of communication between care givers who are family members and the care recipient. Where communications are provided in existing systems the people whom they are interacting with are typically foreign to the care recipient, whether the communications are with an unknown operator, or a computer generated voice.

Thus there remains an unmet need for a personalized home care assistance system that affords comfort and promotes communication between care givers and care recipient; a home care system to monitor, track and/or remind a care recipient of their adherence, or lack thereof, to their medication regimen; a home care system that can alert one or more care providers, care givers, family, care managers, or health plan of the status of a care recipient, adherence with a medication regimen, and the mental, physical, or emotional well-being of the care recipient. There further remains an unmet need to collect data on a care recipient (wellness, medication adherence) without the use of additional devices and making use of a lo-tech, no hardware, no maintenance solution. There further remains un unmet need for an interface of lo-tech hardware, such as a regular telephone landline, and allowing the lo-tech hardware to interface with and be integrated with a high-tech artificial intelligence system that allows care givers to continually monitor and receive updates and notifications of the health and well-being of a care recipient.

### SUMMARY OF INVENTION

A system or method for aiding a care giver is provided which allows for remote and automated care giving services to be provided to a care recipient through the use of interactive communications using interactive care giving software, at least one care recipient device for communicating with a care recipient, at least one care giver computing device having memory for storing computer-executable instructions and a processing unit for executing the instructions stored on the memory, wherein execution of the instructions results in the processing unit performing operations for running said interactive care giving software, and a central processing station for storing information related to a care giver and a care recipient, wherein said central processing station provides communications to a care recipient device, interprets communications from a care recipient device, and provides information and alerts to a computing device. Interactive care giving software is initiated on at least one care giver device and allows a care giver to setup a profile for a care recipient by entering in medical information and answering a series of interactive questions for determining a care recipient's needs. The interactive software communicates and stores the care giver profile information to a central processing station. The central processing station provides regular interactive communication, verbal or written, with a care recipient communication device based on a care recipients profile and stores the information received from the interactive communications to the central processing station. The central processing station communicates the results of the communications by reporting the status of the care recipient on a care giver device, or provides an alert or emergency notification to a care giver device in the event that a care recipient needs assistance, or fails to communicate with an interactive communications from the central processing station. The system can alert or send notifications to care givers, with each notification or alert being sent through a software interface on one or more care giver devices. Notifications or alerts may additionally or alternatively be sent through SMS or email.

In some embodiments, the inventive system creates an interface between a regular telephone landline or mobile phone and an artificial intelligence and voice recognition platform in real-time with an interactive voice response. It is intended that care recipients already have the equipment and do not require additional technology or equipment from the perspective of the care recipient. It is an intended feature of the systems and methods to keep all care givers, family, care managers, and health plan informed of a care recipients medication adherence and their physical, mental and emotional well-being. In addition, it is further an intended feature of the invention to provide status updates of care giver action which can be communicated to family, care givers, care managers to understand what services and activities care givers or care providers are providing to a care recipient, thereby increasing transparency of what care is being received.

A method for providing remote care recipient monitoring by one or more care givers is provided which is directed by a software application on a care giver. A software application is provided to be downloaded and operated on a care giver device which includes a mobile device. The software is intended to provide a family member or care giver the ability to manage and receive reports and tweak setting on a mobile or desktop computing device. Upon initiating the software application on the mobile device, the software application launches and allows a care giver to monitor the status of a care recipient. The status of the care recipient is determined by information received, processed and communicated by a central processing station to a care giver device running the software application showing the status of the care recipient and whether a care recipient is current in the care recipients treatment regimen or medication regimen. Alerts and other push notification are also generated by the software which alerts a care giver to a need or concern for a care recipient.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the disclosure. Moreover, in the drawings, reference numerals designate corresponding parts throughout the several views.

FIG. 1 provides an illustration showing the relationship of a care recipient and a care recipient device to one or more care givers or care giver devices. The outer circle illustrates at least one embodiment relating to the needs of the care recipient that are communicated to the one or more care givers.

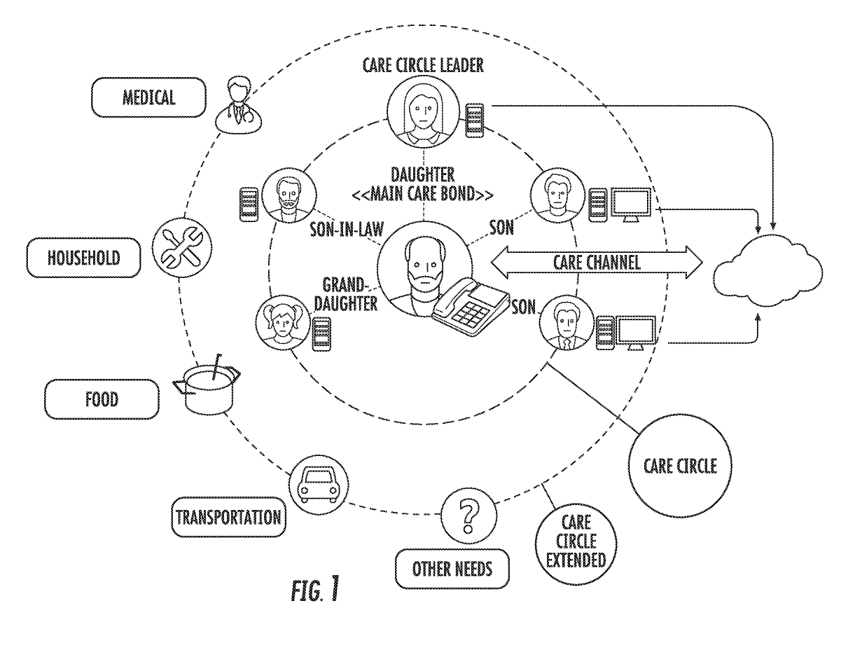

FIG. 2 provides an illustration of the interconnectivity between the care giver device, care recipient device and central processing station.

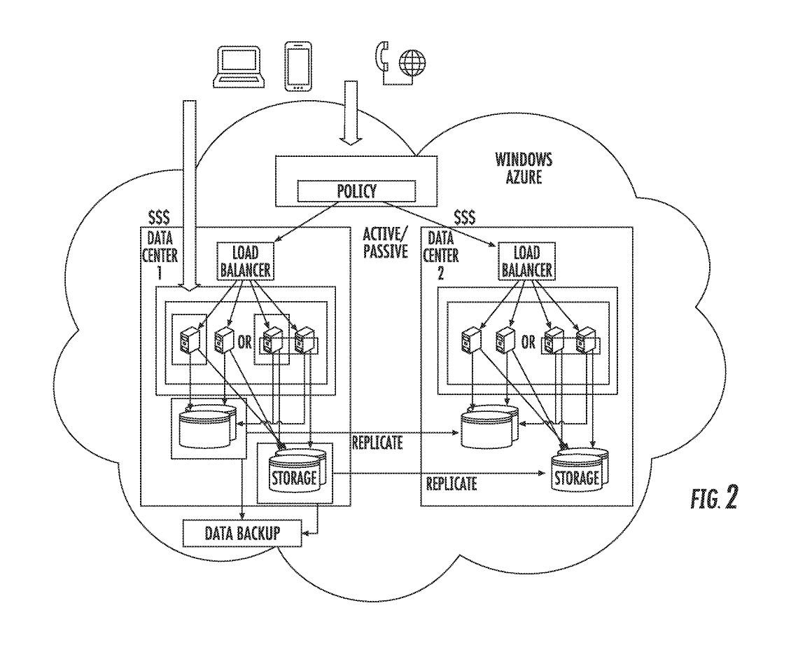

FIG. 3 provides an illustration showing the various information provided in the care giver and care recipient profiles and provides the interrelation of the one or more engines located on the central processing station for interpreting and analyzing the communications to and from the care recipient and determining whether notifications should be sent to at least one care giver or medical provider.

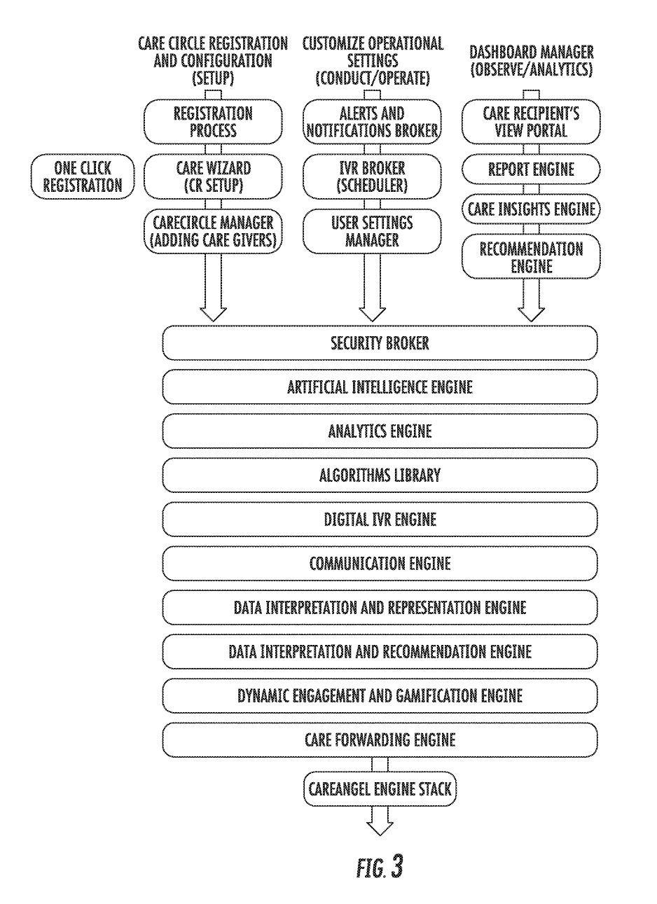

FIG. 4 provides one example of a run-time process of the inventive system illustrating a 41 central processing station employing 42 an interactive voice recognition program to verbally communicate with at least one 43 care recipient using a 44 care recipient device allowing the 43 care recipient and the 41 central processing station to communicate one or more questions, requests, verbal commands. The 41 central processing station further processes the verbal communications received by the 43 care recipient and stores additional information about the 43 care recipient on one or more 46 databases. One or more 45 care givers can remotely monitor or receive updates from the 41 central processing station or the 46 database regarding information pertaining to the 43 care recipient. The 45 care giver may additionally provide updated information to the 46 database and alter the frequency, time of day, or other parameters relating to the run-time process and the care recipient interactive communication from the 41 central processing station.

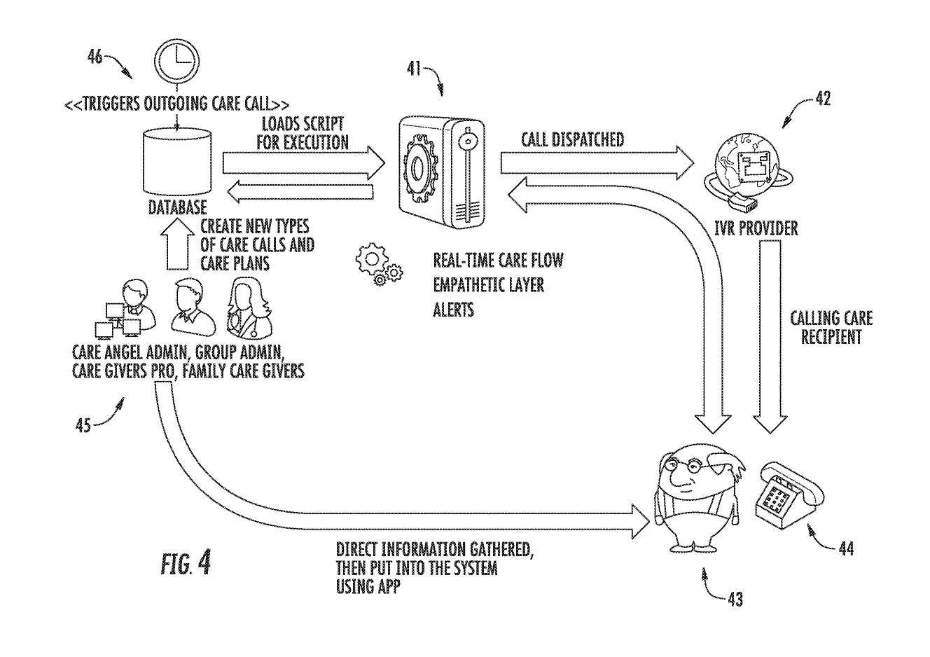

### DETAILED DESCRIPTION OF THE INVENTION

The present invention relates to a system for enabling a personalized care giving experience to a care recipient through the use of continual interactive communication between the system and a care recipient. The present invention does not require the care recipient to own or be tethered to any specialized or impersonal equipment and includes mechanisms to alert a care giver in the event that a dispositive response or no response is provided to certain interactive communications. The present invention further includes a user interface that may be accessed by one or more care givers, who collectively form a care circle for a care recipient, such that the status of a care recipient may be readily reviewed and acknowledged by each care giver in a care circle, and provides more than one care giver whom an alert or notification that a care recipient may need help.

In some embodiments, the care circle may optionally include medical professionals and pharmacists to track the progress of a care recipient and to ensure medication adherence, including that the proper medications are: being timely taken according to a prescribed medication regimen; being prescribed; and fillable. In some embodiments the care plan includes care regimen, health routine, mental, physical, emotional well-being of care recipient including medication adherence. In some embodiments the care circle may also include care management services that includes the above medical professionals and pharmacists to track the progress of a care recipient. The use of the inventive system further employs the option for care givers to pre-record certain messages to be communicated to a care recipient which includes care plan reminders, education content, care instructions. The inventive system optionally allows the use of a care givers voice to be used in the various interactive communications from the system.

Various terms used throughout the specification and claims are defined as set forth below as it may be helpful to an understanding of the invention.

As used herein “Care Circle” shall mean a network of one or more care givers which may further include neighbors, friends, medical and non-medical professionals, transportation services, pharmacists, food delivery services, care management services, care manager, or other personal or medical and non-medical assistance personnel.

As used herein, a “care manager” is one or more person from a care management services company charged for providing care to a care recipient.

As used herein a “network” shall be the Internet, intranets, extranets, wide area networks (WANs), local area networks (LANs), wired networks, wireless networks, or other suitable networks, or any combination thereof.

As used herein a “mobile device” shall be a desktop computer, a laptop computer, a personal digital assistant, a cellular telephone, a set-top box, a music player, a web pad, a tablet computer system, a game console, an electronic book reader, a smartphone, or other type of device with like capability. At a minimum, a mobile device has at least one identification number, a data storage system, an operating system, a central processing unit (CPU), a global positioning system, and an input output (I/O) system capable of communicating to the network.

As used herein a “central processing station” may be a server, computer or any other system providing computing capability. Alternatively, a plurality of central processing stations may be employed that are arranged, for example, in one or more central processing station banks or computer banks or other arrangements. A central processing station may otherwise be a cloud computing resource, a grid computing resource, and/or any other distributed computing arrangement. Such central processing station s may be located in a single installation or may be distributed among many different geographical locations. For purposes of convenience, the central processing station is referred to herein in the singular. Even though the central processing station is referred to in the singular, it is understood that a plurality of central processing station s may be employed in the various arrangements as described herein.

As used herein a “central processing unit” or “processor” may represent multiple processors and each “memory” or “data storage system” may represent multiple memories which operate in parallel processing circuits, respectively.

### System—General

A system or method for aiding a care giver is provided which allows for remote and automated care giving services to be provided to a care recipient through the use of interactive communications using interactive care giving software, at least one care recipient device for communicating with a care recipient, at least one care giver computing device having memory for storing computer-executable instructions and a processing unit for executing the instructions stored on the memory, wherein execution of the instructions results in the processing unit performing operations for running said interactive care giving software, and a central processing station for storing information related to a care giver and a care recipient, wherein said central processing station provides communications to a care recipient device, interprets communications from a care recipient device, and provides information and alerts to a computing device. It is understood that in at least one embodiment the care recipient device is a wired touch tone telephone. Other embodiments may include alternate modalities of electronic or written communication known in the art, including cellular, SMS, texting, email, postcards or snail mail.

Interactive care giving software is initiated on at least one care giver device and allows a care giver to setup a profile for a care recipient by entering in medical information and answering a series of interactive questions for determining a care recipient's needs. The interactive software communicates and stores the care giver profile information to a central processing station. The central processing station provides regular interactive communication, verbal or written, with a care recipient communication device based on a care recipients profile and stores the information received from the interactive communications to the central processing station. The central processing station communicates the results of the communications by reporting the status of the care recipient on a care giver device, or provides an alert or notification of an adverse situation or noncompliance with a care giver plan or medication regimen to a care giver device in the event that a care recipient needs assistance, or fails to communicate with an interactive communications from the central processing station.

In at least one embodiment, the inventive system dispatches a call to a care recipient at a certain time (with a pre-defined frequency) having objective of checking on how the care recipient is doing, checking if care recipient follows doctor's orders (routine, medications, etc.), harvest important vital readings, elevate care recipient mood, or project a sense of care for the care recipient.

In at least one embodiment the inventive system communicates with the care recipient following a flow of questions suggested by care giver when an account is setup by a care giver on one or more care giver computing devices. Using the information provided in the account setup by a care giver, the system will store in one or more database information such as the care recipient's name, medical conditions, preferences (voice, language).

In at least one embodiment, and through the use of one or more interactive verbal communication program, the inventive system engages in human-like conversation with a care recipient.

In at least one embodiment, the inventive system collects and stores additional information about a care recipient based on a care recipients responses or interactions with the system, or through information being updated by one or more care givers having access to a care recipients account or profile.

### Care Recipient Device

A care recipient device is intended to be used for communicating to and/or from the system to a care recipient. A care recipient device is at least one of a line based telephone system, a television, a computer, a mobile device, a cellular telephone, a tablet, or other device for communicating messages from a care giver or a central processing station to a care recipient. While it is a goal of this invention to aide a care recipient without any specialized devices, it is understood that each care recipient has different understanding of technology, thus the system described herein is intended to communicate with each care giver device disclosed herein and known in the art, and without requiring the use of any new technology or having to purchase additional equipment. In some embodiments, a care giver may alternately provide a mobile device or other communication device to act as a care recipient device.

In one embodiment of the invention, the care recipient device receives commands or communications from a care recipient. The communications from the care recipient include voice recognition, voice commands, text commands, touch commands or key tone commands. In at least one embodiment, the commands or communications from the care recipient device receives commands or communications in verbal from the care recipient which are interpreted and analyzed by the central processing station to provide analytics and recommendations to the care recipient and the care giver. In other preferred embodiments combination of voice, touch commands, key tone commands, and third party device information may be used to communicate care recipient information to the systems central processing station for interpretation and storage.

### Care Giver Device

One or a plurality of care givers and care giver devices may be used for interaction with the inventive system. In each instance a care giver device must be a computing device having the ability to send and receive data, and to have certain processors and component in order to execute certain functions and interpret certain data to make a useful representation of the information received from the system, and in order to effectively communicate information or requests from care giver device to the system. It is appreciated that several computing devices are available on the market and are known in the art, and nothing herein shall limit the selection of a computing device which communicates with the inventive system. In some embodiments, a computing device is a mobile device, a smart device, a desktop computer, a laptop computer, a tablet, a smart watch, a smart television, a device containing a CPU and RAM, or combinations thereof.

### Central Processing Station

The central processing station is a critical component to the inventive system and is involved as the central processing point of all data collected from interactive communications with a care recipient, all data and information collected from care recipient profile, any information provided from a care giver device, and runs certain programs and algorithms to determine what questions to ask a care recipient during an interactive communication session between the central processing station and a care recipient device. The central processing station further determines when to send out alerts or notifications to one or more care givers or to a care circle containing a plurality of care givers, medical personnel and pharmacists of a care recipient.

The central processing station is responsible for initiating communication based monitoring with a care recipient based on a care giver profile. In some embodiments the central processing station initiated communication based monitoring includes at least one question relating to a care recipients well-being, vital sign reporting, and medication adherence. The monitoring of the well-being of a care recipient includes an interactive communication from the central processing station to a care recipient through the use of a care recipient device a series of questions relating to, but not limited to, a care recipients condition, feeling, pain, sleep, need for transportation, appetite, needs, water intake, exercise, current weight, or combinations thereof. The monitoring of the vitals of a care recipient includes an interactive communication from the central processing station to a care recipient through the use of a care recipient device is a series of questions communicated to a care recipient relating to a care recipients reporting blood pressure, blood glucose, blood oxygen, or combinations thereof.

In some embodiments, the monitoring of the vitals of a care recipient may also be reported by one or more medical devices, heart rate monitors, motion trackers, activity trackers, blood pressure machines, medical devices, electronic pill boxes, mobile devices, GPS trackers or combinations thereof. The monitoring of medication adherence includes an interactive communication from the central processing station to a care recipient through the use of a care recipient device is a series of questions communicated to a care recipient to determine whether a care recipient has taken their medication, is in need of medication, has missed taking certain medications or combinations thereof. In some embodiments the central processing station receives information including medication adherence and vital monitoring from third party databases or devices.

In at least one embodiment, the central processing station may store one or more pre-recorded messages from a care giver to use for the interactive communication, or to greet the care giver at some predetermined time, or as a part of the interactive communication between the central processing station and said care recipient. In some embodiments the interactive communication is made using a pre-recorded message or synthesized message using or simulating at least one care giver's voice. In some embodiments the interactive communications may include care instructions, care plans, reminders and follow up.

Upon the central processing station initiated communication to a care recipient, the central processing station stores and interprets the responses from a care recipient in real-time to determine whether a care recipient needs assistance. In at least one embodiment, the central processing station determines one or more alerts or notifications to be provided from a central processing station to a care giver device based on the interpretation of the information received from the care recipient as a result of the interactive care giver communications. In some embodiments, if the central processing station determines through data processing of the care giver responses, or the care giver information provided by any medical device or vital sign monitoring technology, whether a care recipient needs assistance. In such instances where the need of assistance is determined, the central processing station contacts a care giver, a care recipients doctor, emergency medical support, a pharmacy, a family member, a friend of the care giver, an emergency contact of the care giver, or combinations thereof. It is appreciated that the central processing station may contact the care giver, a plurality of care givers, one or more persons in the care circle, or care recipient may subscribe to additional services of available persons. In at least one embodiment the additional services may include, but not limited to, nursing services, care management services, transportation services, food delivery services, mobile medics, or medication delivery services.

It is also intended for the central processing station to interpret, analyze, and record data collected from an interactive communication, and provide recommendations or follow up questions based on the commands and communication received from a care recipient. To achieve this, it is intended as part of the interactive communications initiated by the central processing station to converse with the care recipient based on the communications received from the care recipient. In at least one embodiment, where a care recipient indicates that a monitored parameter, mood, feeling, or need is out of the ordinary, the central processing station will initiate one or more questions to narrow down the problem and provide one or more solution options to a care recipient or provide one or more notifications to a care giver or to a care circle.

In order to process the care recipient information, the central processing station contains a number of engines each to perform specific functions in real-time. In at least one embodiment the central processing station includes an engine stack having one or more engines or subsystems. These subsystems include a Security Broker Engine, an Artificial Intelligence Engine, an Analytics Engine, an Algorithms Library, a Digital IVR Engine, a Communication Engine, a Data Interpretation and Representation Engine, a Data Interpretation and Recommendation Engine, a Dynamic Engagement and Gamification Engine, and a Care Forwarding Engine.

In some embodiments, where incorporated, the Security Broker Engine focuses on the security aspects of the entire system. It deals robustly with possible sources of disruption ranging from malicious acts to unpredicted system failures. It supports the delivery of engineering solutions that satisfies pre-defined functional and user requirements, but with the added dimension of preventing misuse and malicious behavior. The security engine assures information security and protects data from unauthorized access, use, disclosure, destruction, modifications, or disruption to access. The sensitive users' data is stored in the secure location in the encrypted form. The data exchange at the application level if fully protected from the unauthorized users, since the data doesn't leave the secure domain on the central processing station s. Data delivered to user's devices is transmitted over the secure channels.

In some embodiments, where incorporated, the artificial intelligence engine (AIE) is built to generate human-like behavior and response as all types of users interact with the platform. During interactive voice recognition (IVR) calls, AIE recognizes Care Recipients' responses and adjusts the tone of the IVR system, changes the prompts to include the element human-like, empathetic response. AIE uses puts a wealth of information at user's fingertips in real time. AIE uses complex computer algorithms to make sense of unstructured data. It can discern useful patterns from the data collected and transforms these finding into actionable intelligence. AIE provides machine learning capabilities, and incorporates new finding in operating algorithms. It grows more powerful over time based on the data collected from the patient either by direct user input, and by recording and interpreting the responses of the care recipient.

In some embodiments, where incorporated, the Analytics Engine is designed to discover and communicate the meaningful patterns in data collected. It relies on simultaneous application of statistics, computer programming and operations research to quantify and qualify performance. The engine allows data visualization to communicate the insights. The engine applies analytics to describe, predict and improve overall wellness of the care recipients.

In some embodiments, where incorporated, the Algorithms Library engine is a repository for a constantly growing library of algorithms primarily used for data mining and producing meaningful outputs based on the information available. The algorithms allows care givers and other authorized stakeholders to quickly determine a state of a particular care recipient without examining the large amount of data manually. The most important group of such algorithms is dedicated to yield an accurate answer of how a care recipient is doing overall based on his/her answers and on the vital readings provided. The Algorithms Library is heavily used by other engines, including data interpretation and representation engine, Data Interpretation and Recommendation Engine, artificial intelligence engine.

In some embodiments, where incorporated, the Digital IVR Engine generates the voice used for the interactive communications with a care recipient. The engine includes a number of components, including IVR flow builder, IVR flow scheduler, and IVR flow executor. The IVR flow builder receives a request from the scheduler about a call of a certain type to be dispatched sometimes in the future to a particular care recipient with a specified phone number. The builder resolves as much specifics as possible in pre-run time to relief the executor component of addressing those specifics in the actual execution time or run-time. The values resolved typically include language IVR voice will speak, voice preference (male/female, accent), specific prompts to be used, any requested block of questions for that call, etc. After the blue print of the future call is built, it is stored in the data store and scheduled for future invocation. When the call is dispatched, the IVR executor starts its work. As already mentioned, many steps of the flow are pre-determined, and yet many steps will have to be resolved dynamically, depending on real-time answers provided by care recipient. In some embodiments, before executing the call, the engine will first determine that the system speaks with Care Recipient. The steps include the routine identifying if IVR ‘talks’ to an answering machine or voice mail. In at least one embodiment, if the right care recipient is reached, the IVR will ask if it's a good time to call. If yes, the pre-built flow will start its execution.

It has been established that most systems fail as a result of a user hearing the same prompts from the system on each call is not the best user experience. Thus in some embodiments, the system provides three prompt modes to communicate with the user: normal, concise/conversational modes, verbose (instructional) and numeral input modes. In those embodiments, in the first few calls the users will be offered prompts with minimum instructions attached. If system detects that the user has difficulties providing meaningful answers, it will read back more detailed prompt by switching to the verbose mode. After a few calls, the user most likely will know how to communicate back to the IVR system. No detailed prompts are needed at this point, and that is why the IVR engine will be run in concise mode, servicing short prompts.

The IVR engine can take users' input in two different ways—recognizing words spoken by the user and interpreting numeric keys values pressed by the user on the phone. In such embodiments, the IVR engine operates in the mixed mode, ready to take the inputs via words or digits from the pad. If user's voice input is not clear, the IVR engine will prompts the user about switching to the numeric mode only. That will guarantee the accurate readings received by the system.

In some embodiments, where incorporated, the Communication Engine addresses the issues of providing extensive communication possibilities to the care recipient, care giver, and/or care circle. In at least one embodiment, the Communication Engine is responsible for delivering a messages of various types to the intended recipients. In case of sending a direct message from a sender to a receiver, the Communication Engine simply provides the delivery mechanism, such as email, SMS, voice call, voice message, etc. In case of sending a notification or an alert, the Communication engine offers a few more layers of functionality. In its simplest form, when a specific event takes place within the system application domain, a number of potential subscribers to the event needs to be notified. The engine first identifies the recipients, then the engine resolves communication modalities that are set as default preferences or explicitly requested modalities. Then the Communication Engine call the message presentation component, that is responsible for building the message in the way it will be used in the specific communication modality context. Only then the messages will be supplied into the actual delivery pipe.

In some embodiments, where incorporated, the data interpretation and representation engine is responsible for extracting useful information out of data harvested and presenting it in a very easy to understand format. At a glance, the users of the platform will know how their loved ones are doing. That is achieved by offering custom designed iconography that is easy to interpret. In some embodiments, basic icons including, but not limited to, a ‘happy face’, ‘neutral face’, ‘sad face’, and ‘did not answer the call’ and colors such as red yellow, green or other colors that symbolize a status. While underlying algorithms of interpreting well-being of a Care Recipient could be complicated, the output shown in the form of an icon is a very effective way to display a summary of how the loved one is doing. If more complex analytics need to be viewed, the data presentation engine provides with more in-depth graphs and reports, organized by range and type. The types include well-being reports, vital reading reports, and medication reports.

In some embodiments, where incorporated, the Data Interpretation and Recommendation Engine can be viewed as a subset of the artificial intelligence engine (AIE). The core of the engine is built by the data, information, knowledge components. In some embodiments, it includes the specifications, organization and interrelationships between data, information and knowledge elements that the engine requires. The combination of all these different parts is made by intelligent data-mining algorithms, rule engines and analytical processes. From the storage and computation of raw data, this leads to the transformation into information to serve an output for platform and users, in order to make an informed and intelligent decisions. Interpretation of the data user provided based on proprietary algorithms, protocols and community standards of care and industry known ranges will allow for evidence-based recommendations to the care recipient and care giver that are specific to CG & CR conditions, medications and other known facts and environmental variables.

In some embodiments, where incorporated, the Dynamic Engagement and Gamification Engine aims to engage, inform, educate and encourage users to change their activity of daily living and behavioral patterns. Harnessing digital stimuli and score keeping to make the most of a person's natural, psychological and behavioral inclination toward fun and competition provide outstanding potential benefits.

In some embodiments, where incorporated, the Care Forwarding Engine is equipped with functionality that will recognize if a care recipient needs assistance from someone in the extended care circle in cases when the inner circle's help is not enough or not even available. In certain embodiments, notifications may be sent to one or more care givers which may further include neighbors, friends, medical and non-medical professionals, transportation services, pharmacists, food delivery services, care management services, care manager, or other personal or medical and non-medical assistance personnel relating to an out-of-range vital readings or other abnormality based on a care recipient report. In some embodiments, an auto prescription refill request is another example of care forwarding use cases. The engine will be able to dispatch requests (including but not limited to) for transportation, house services, food deliveries. The Care Forwarding Engine is constantly listening for specific signals directly from care recipient, care givers or it raises proper event itself as it analyzes data collected. Then automated requests for care are generated and forwarded to the appropriate channels.

In some embodiments other engines may be employed such as a Branding Engine which provides the ability for creating a branded user experience for populations they want to give this to from a particular brand (brought to you by Walgreens) or a Registration Engine which allows the central processing station to send links based on someone mobile number to their text service which allows reminders to be sent via SMS for registration.

The central processing station further includes software and at least one executable to communicate with one or more care giver devices or interactive care giving software on one or more care giver devices. To the extent that a care giver enters information on the interactive care giving software to include one or more additional care givers, the central processing station communicates an invitation to one or more of said plurality of care giving devices to form a care circle for a care recipient.

It is intended in some embodiments that the interactive care giving software is modifiable by a care giver to modify central processing station setting for the frequency of care recipient interactive communications, type of care recipient interactive communications, for the medical profile of a care recipient, doctor information of a care recipient, medical information pertaining to a care recipient.

### Systems-Software Package

The interactive care giving software stored on one or more care giver devices provides instructions, protocols and subroutines to interpret commands from a care givers input, and to process the data to be sent or received from the central processing station, and to run the essential executable to communicate with one or more care giver devices used with the system. The interactive care giving software also provides an interactive graphical user interface on the display of the care giver device displaying data, information, alerts or notifications received by the care giver device from the central processing station. In some embodiments the interactive care giving software includes an interface for alerting a care giver device when a recipient has not responded to at least one interactive question or has not responded to at least one interactive question positively. In at least one embodiment the interactive care giving software includes an interface for alerting a care giver device when a recipient is in need of help or an emergency. In certain embodiments the interactive care giving software allows for any care giver device to immediately communicate a message to said care recipient by recording a voice message to be transmitted to a care recipient device from the central processing station, by testing or emailing a message to the central processing station which converts the email or text to a verbal communication sent to a care recipient device from the central processing station, or directly connects a care giver device to a care recipient device.

The interactive care giving software includes an interface for a care giver device for communicating with the central processing station for receiving and displaying information related to at least one care recipient or a plurality of care recipients. In addition a care giver may interact with the graphical user interface with touch command, with a mouse, a controller or with voice recognition or voice commands.

### Method—General

A method for providing remote care recipient monitoring by one or more care givers is provided which is directed by a software application on a care giver. A software application is provided to be downloaded and operated on a care giver device which includes a mobile device. Upon initiating the software application on the mobile device, the software application launches and allows a care giver to monitor the status of a care recipient. The status of the care recipient is determined by information received, processed and communicated by a central processing station to a care giver device running the software application showing the status of the care recipient and whether a care recipient is current in the care recipients treatment regimen or medication regimen. The software application is used to setup a care recipient profile including one or more of the care recipients treatment regimen, mental physical and emotional well-being, a care plan, medication and treatment. Other settings such as notification settings, communication frequency and types, as well as alerts and other push notification are also setup by the software which alerts a care giver to a need or concern for a care recipient.

The method further includes the software to store a care recipient profile on the central processing station and to interact with the central processing station to provide status of a care recipient and notifications based on a care recipients responses.

The method further includes communicating with a care recipient based on the care recipient profile stored on the central processing station. In some embodiments the central processing station initiates interactive verbal recognition systems to interactively communicate with one or more care recipient. The information is stored or interpreted on the central processing station, and analyzed to determine if one or more care giver or care recipient needs to be notified. When the central processing station detects a lack of response, or an abnormal response, the central processing station will initiate a notification on one or more care giver device of the abnormality or missed communication.

### Examples

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

### Example 1—Initial Setup

A care giver desiring to use the inventive system first downloads the interactive care giving software to a care giver mobile device. Upon the initial launch of the software, the care giver creates an account by providing personal information of the care giver such as their name, address, mobile number and email. The care giver is further asked to choose a password. The care givers profile information is stored on the central processing station and may be used to login on one or more other devices.

Upon the initial login to the software, the care giver is asked to select one or more persons whom the care giver wishes to provide remote interactive care using the inventive system. The care giver enters the name and relationship to the care recipient. The interactive care giving software prompts the care giver to provide information about the care recipient such as the care recipients name, date of birth, phone number, and home address. The care giver selects their mother and enters her name and other requested information. This sets up the care recipient profile which is saved to the central processing station and may be accessed by one or more devices connected to the system.

The care preferences for the care recipient are then added to the care giver profile by the care giver. The care preferences are a series of questions to establish the baseline information in order for the system to evaluate the care recipients health during future interactive communications. The care givers rating of the care recipients health is provided in addition to the care recipients height, weight, known medical conditions and severity. The care preferences further include questions relating to the type of medical conditions listed, such as blood pressure, blood glucose levels, or oxygen levels. The care preferences further include questions relating to the type of medications and frequency of mediation needed by the care recipient. The care recipient preferences are saved on the central processing station and may be accessed by one or more mobile devices connected to the system if invited by the care giver to share the care recipient profile.

The care recipient communications are then setup by the care giver. First the care giver selects the mode of communication in which the care recipient receives the interactive communication and messages. The care giver is given a menu of care giver devices to choose from including a wired telephone or a cellular phone. The care giver selects that the communications to the care recipient are to be made to a wired telephone, and the care giver selects the number which the interactive communications and messages are to be delivered. The interactive care giving software further allows the care giver to setup the time and frequency for sending calls. The care giver is given the option to setup one or more greeting calls to the care recipient, and selects to send a message to the recipient (one to three or more times) per day to ensure that the care recipients mental physical emotional well-being is being monitored in addition to whether the care recipient has had their meal and respective medication adherence. The care giver is provided an option to record a personal message from the care giver, or to use a pre-recorded, computerized voice to convey the care recipient message. The care giver selects the option to record a personal message for each of the three care giver messages to be delivered to the care recipient in a day.

After the setup, the care giver is further given the option to pre-record one or more personalized messages for special care instructions, to be delivered to a care recipient for one or more special occasions. The care giver selects the option and records a mother's day greeting and a birthday greeting for the care recipient. The care giver ends the communication setup and the preferences and recordings are saved on the central processing station.

The care giver is given an option to edit any of the preferences when logged into the interactive communication software at any time.

### Example 2—Care Giver Notifications

The care giver has installed the interactive communication software on the mobile device of the care giver and has setup a care recipient profile similar to Example 1. The care recipient has been receiving messages and interactive communications and information has been stored by the system central processing station through an interactive voice recognition and artificial intelligence platform. The information recorded from each communication session is stored and analyzed on the system central processing station by the plurality of information processing engines being used on the central processing station.

The care recipient misses a scheduled communication as programmed in Example 1. Upon two or more attempts at initiating communication, depending on the notification profile, a notification is sent to the care giver. In the event that the care giver fails to access the interactive communication software located on the care giver device, the message may be escalated to a text message. Other notifications are provided when the care recipient indicates that they aren't feeling well, they are in pain, that they failed to take all or some of their medication, failed to check the vitals or other medical monitoring setup in the care recipient profile, if one or more vitals are abnormal or critical levels, or if the care recipient responds to any interactive communication with the response “help” or “hello angel”.

For each notification, the notification provided by the interactive care recipient software provides an option for a care giver to call the care recipient with a one touch option.

### Example 3—Care Recipient Experience

The care recipient profile is setup by a care giver similar to Example 1. According to the communication profile setup for the care giver, one to three or more interactive communications are setup by the care giver for the care recipient to check on the care recipient's mental, physical, emotional mood, physical health, and compliance with medication and vital sign monitoring. Other options for interactive communication with the care recipient described herein were not included in the care recipient profile. The one or more engines of the central processing station interpret the profile information and initiate a first interactive communication and message session with a care recipient device, which is setup to be the care recipients wired home telephone. The care recipient's telephone rings, but it is not answered. After an amount of time passes based on the communication profile, the central processing station re-attempts to make the call until the care recipient answers. Upon the second attempt, the care recipient answers the telephone.

Upon answering the telephone, the care recipient is greeted on the phone. In this case the care giver did not pre-record any personalized messages, and a pre-recorded human-like artificial intelligence message and voice is used for the communications (“Angel”). The care recipient is hears the following message:

“GOOD MORNING MARY, THIS IS CARE ANGEL. THIS WILL ONLY TAKE A MINUTE OR TWO. I AM HERE TO HELP KEEP YOU HEALTHY, SAFE AND REMIND YOU TO TAKE YOUR MEDICATIONS, CHECK YOUR HEALTH, SEE IF YOU NEED ANYTHING AND SEE HOW YOU ARE FEELING I'LL EVEN ALERT YOUR LOVED ONES AND CARE CIRCLE WHEN SOMETHING ISN'T RIGHT. NOW LETS BEGIN” The care recipient responds by saying “yes”. The care recipient is given the option to use touch commands on the touch tone phone instead of the interactive voice recognition communication. The care recipient continues to engage in the interactive communication verbally. “Angel” empathetically and appropriately responds to create a human-like experience.

The central processing station reviews the communication profile and the care preferences profile for the care recipient profile and begins to ask the care recipient questions. The system asks “HOW DID YOU SLEEP LAST NIGHT?” The care recipient responds “Good.” “HOW ARE YOU FEELING RIGHT NOW?” The care recipient responds “Good.” The system asks “DO YOU HAVE ANY PAIN?” The care recipient responds “No”. The system asks “DO YOU NEED ANYTHING-LIKE MEDICAL SUPPLY, PRESCRIPTION REFILLS, FOOD, TRANSPORTATION OR OTHER THINGS?” The care recipient responds “Food”. The central processing station interprets the response and sends the appropriate notification to the care giver.

The system next asks, “DID YOU TAKE YOUR MEDICATIONS THIS MORNING?” The care recipient responds “Yes”. The system next asks, “DID YOU TAKE “ALL” OR “SOME”?” The care recipient responds “Some”. The system provides a notification to the care giver. The system further inquiries why only why some of the medications were taken. The system provides an option to “SAY RAN OUT IF YOU RAN OUT OF YOUR MEDICATION.” The care recipient responds “Ran out”. The system provides a notification to the care giver and optionally a pharmacist or the medical provider for the care recipient if the pharmacist or medical provider are part of the care recipient care circle.

The care recipient profile and care preferences indicate that the care recipient needs to report their blood pressure and blood sugar levels. The system next asks, “What was your Blood Pressure?”. The care recipient responds “120 over 80”. The system asks, “What was your Blood Sugar? The care recipient responds 110. The system interprets the care recipients responses and compares the blood pressure and blood sugar levels against the normal levels and critical levels of the care recipient. The blood pressure levels and blood sugar levels are determined to be normal, and no notification is provided to the care giver or any member of the care circle.

Upon completion of the interactive interview of the care recipient, the care recipient is provided the option to record a message for one or more care giver in a care circle, or to directly call one or more care giver in the care circle. The care recipient does not select any option and the interactive communication session ends. The care recipient hangs up the telephone.

### OTHER EMBODIMENTS

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the described embodiments in any way. Rather, the foregoing detailed description will provide those skilled in the art with a convenient road map for implementing the exemplary embodiment or exemplary embodiments. It should be understood that various changes can be made in the function and arrangement of elements without departing from the scope as set forth in the appended claims and the legal equivalents thereof.

1. A system for aiding a care giver, the system comprising:
a communication network, the communication network comprising at least one of a cellular data or tele-communications network, a wired tele-communications network, and a Wi-Fi network;
at least one care recipient device for communicating between a care recipient and a central processing station;
at least one care giver computing device, the care giver computing device comprising memory and a processing unit for storing and executing software for interfacing and communicating with the central processing station for updating care recipient information, and for monitoring notifications related to at least one of the physical well-being, mental well-being, emotional well-being, vital sign reporting, and medication adherence of the care recipient; and
a central processing station employing interactive care giving software for storing information related to at least one care giver, at least one care recipient, at least one care giver computing device, at least one care recipient device, the interactive care giving software comprising at least an interactive voice recognition engine wherein said central processing station interactively and verbally communicates with a care recipient through communication with a care recipient device using the communications network, interpreting the verbal communications received from the care recipient, and communicating with at least one care giver device notifications related to at least one of the health, medication adherence, the emotional well-being, and the physical well-being of the care recipient.

2. The system of claim 1 wherein the at least one care recipient device for communicating with a care recipient is a line based telephone system, a television, a computer, a mobile device, a tablet, or other device for communicating messages from a care giver or a central processing station to a care recipient, or combinations thereof.

3. The system of claim 1 wherein the at least one computing device is a mobile device, a smart device, a desktop computer, a laptop computer, a tablet, a smart watch, a smart television, a device containing a CPU and RAM, or combinations thereof.

4. The system of claim 1 wherein said monitoring of well-being includes an interactive communication from the central processing station to a care recipient through the use of a care recipient device, wherein said interactive communication is a series of questions communicated to a care recipient relating to a care recipients mental well-being, physical well-being, condition, feeling, pain, sleep, need for transportation, appetite, needs, water intake, exercise, current weight, or combinations thereof.

5. The system of claim 1 wherein said monitoring of vitals includes an interactive communication from the central processing station to a care recipient through the use of a care recipient device, wherein said interactive communication is a series of questions communicated to a care recipient relating to a care recipients blood pressure, blood glucose, blood oxygen, or combinations thereof.

6. The system of claim 1 wherein said monitoring of medication adherence includes an interactive communication from the central processing station to a care recipient through the use of a care recipient device, wherein said interactive communication is a series of questions communicated to a care recipient, care manager, or professional care worker to monitor activities of daily life (ADL) including food prep, bathing, laundry, grooming, toileting, to determine whether a care recipient responds to care recipient device, to determine whether a care recipient has taken their medication, is in need of medication, or combinations thereof.

7. The system of claim 1 wherein said care recipient responses to communication based monitoring initiated by the central processing station is stored on the central processing station and are interpreted to determine whether a care recipient needs assistance.

8. The system of claim 1 wherein said communication from said central processing station are pre-recorded messages using at least one care giver voice which may include care plans, care reminders, care instructions or combinations thereof.

9. The system of claim 7 wherein if the central processing station determines through data processing whether a care recipient needs assistance, the central processing station contacts a care giver, a care recipients doctor, emergency medical and non-medical support, a pharmacy, a family member, a friend of the care giver, an emergency contact of the care giver, or combinations thereof.

10. The system of claim 7 wherein said data processing is performed in real time, over time based on data that it has already collected, or combinations thereof.

11. The system of claim 1 wherein the central processing station further comprises an engine stack having one or more engines or subsystems, said engines or subsystems selected from the group consisting of Security Broker, Artificial Intelligence Engine, Analytics Engine, Algorithms Engine Library, Digital IVR engine, Communication Engine, Data Interpretation and Representation Engine, Data Interpretation and Recommendation Engine, Dynamic Engagement and Gamification Engine, and Care Forwarding Engine, Dynamic Registration Engine, Dynamic Branding Engine.

12. The system of claim 1 wherein said interactive care giving software includes an interface for a care giver device for communicating with the central processing station for receiving and displaying information related to at least one care recipient.

13. The system of claim 1 wherein said interactive care giving software includes an interface for alerting a care giver device when a recipient is in need of help or an emergency.

14. The system of claim 1 wherein said interactive care giving software causes the central processing station to interface with at least one care recipient device for alerting a care giver when a recipient has not responded to at least one interactive question or has not responded to at least one interactive question positively.

15. The system of claim 1 wherein said central processing station receives additional patient information from additional care recipient devices, said devices comprising: heart rate monitors, motion trackers, activity trackers, blood pressure machines, medical devices, electronic pill boxes, mobile devices, GPS trackers, third parties databases, or combinations thereof.

16. The system of claim 1 wherein said verbal communication from the central processing station is made using a pre-recorded message or synthesized message using or simulating at least one care giver's voice for simulating a normal human conversation.

17. The system of claim 1 wherein said interactive care giving software is modifiable by a care giver to modify central processing station setting for (including but not limited to) the frequency of care recipient interactive communications, type of care recipient interactive communications, for the medical profile of a care recipient, doctor information of a care recipient, medical information pertaining to a care recipient.

18. The system of claim 1 wherein said interactive care giving software allows for any care giver device to immediately communicate a message to said care recipient by recording a voice message to be transmitted to a care recipient device from the central processing station, by testing or emailing a message to the central processing station which converts the email or text to a verbal communication sent to a care recipient device from the central processing station, or directly connects a care giver device to a care recipient device.

19. The system of claim 1 wherein said care recipient may communicate with an interactive communication menu located on a central processing station allowing said care recipient to communicate one or more care givers directly.

20. A non-transitory computer-readable medium containing computer-readably instructions which, when executed, cause a computer to provide remote care recipient monitoring by one or more care givers, the process comprising:
accessing a care recipient profile;
interpreting information recorded in a care recipient profile including a requested call frequency, medication regimen, and baseline or previous physical, mental and well-being of a care recipient;
communicating one or more questions to a care recipient on a care recipient device using an interactive human-like, empathetic computer managed interview;
recording one or more responses provided by a care giver and interpreting and recording the response;
determining from one or more responses whether additional questions need to be communicated to the care recipient;
determining from one or more responses whether a notification should be sent to a care giver, a care manager, a family member, or a member of the care recipients care circle;
providing a status update to one or more care giver devices.
